(19) United States
(12) Patent Application Publication
(10) Pub. No.: US 2026/0180277 A1
(43) Pub. Date: Jun. 25, 2026

(54) All-Fiber Laser System With Intrinsic Isolation Of Backward-Propagating Optical Radiation

(71) Applicant: Lightel Technologies, Inc., Renton, WA (US)

(72) Inventors: Chungho Hsia, San Jose, CA (US); Pai-Sheng Shen, Bellevue, WA (US)

(73) Assignee: Lightel Technologies, Inc., Renton, WA (US)

(21) Appl. No.: 19/433,803

(22) Filed: Dec. 27, 2025

Related U.S. Application Data
(63) Continuation-in-part of application No. 19/001,331, filed on Dec. 24, 2024.

(51) Int. Cl. H01S 3/094; H01S 3/067; H01S 3/108; H01S 3/30

(52) U.S. Cl. CPC H01S 3/094019; H01S 3/0675; H01S 3/094007; H01S 3/1086; H01S 3/302

(57) ABSTRACT

An all-fiber laser system includes a gain fiber and a fiber-based optical coupling structure configured to introduce pump light into a signal fiber. The optical coupling structure provides intrinsic isolation of pump fibers from backward-propagating optical radiation generated in the gain fiber, including backward-propagating signal light and stimulated Raman scattering (SRS) light. By structurally suppressing coupling of the backward-propagating optical radiation into the pump fibers, the laser system mitigates population inversion collapse and suppresses laser instability and self-pulsation induced by optical back reflection during processing of reflective materials. The system enables stable continuous operation at multi-kilowatt output power without reliance on free-space optical isolators, circulators, or active shutdown mechanisms, thereby improving reliability of pump light sources and protecting an output fiber during high-power laser operation.

### CROSS REFERENCE TO RELATED APPLICATION(S)

The present disclosure is a continuation-in-part (CIP) of U.S. patent application Ser. No. 19/001,331, filed on Dec. 24, 2024, the entire contents of which are incorporated herein by reference.

### TECHNICAL FIELD

The present disclosure relates to all-fiber laser system for processing highly reflective materials. More particularly, the system employs an isolating side-pumped signal-and-pump combiner configured to withstand strong back-reflection from copper and other highly reflective workpieces, thereby improving system reliability and longer continuous operating time without protective system shutdown.

### Definitions and Terminology

For purposes of this disclosure, the following terms and phrases are defined or described. These definitions apply unless the context clearly indicates otherwise. The definitions are intended to clarify terminology used herein and are not intended to limit the scope of the disclosure.

“Isolating side-pumped combiner” refers to a side-pumped signal-and-pump combiner configured to inject pump light laterally into a signal fiber while structurally inhibiting coupling of backward-propagating signal light and stimulated Raman scattering (SRS) light into pump fibers, thereby providing intrinsic optical isolation of pump light sources.

“Side-pumped signal-and-pump combiner” refers to a fiber-based optical device in which one or more pump fibers are optically coupled to a signal fiber in a lateral or side-coupled configuration, such that pump light is injected into a cladding region of the signal fiber while a signal propagates through a core of the signal fiber.

“Backward-propagating optical radiation” refers to optical power propagating opposite to a primary signal direction, including back-reflected signal light and backward-propagating stimulated Raman scattering (SRS) light.

“Self-pulsation” refers to spontaneous, high-frequency temporal modulation of laser output power caused by rapid population inversion changes in a gain medium, resulting in optical pulses having peak power substantially exceeding an average output power.

“Intrinsic isolation” refers to suppression of coupling of backward-propagating optical radiation into pump fibers by structural configuration of a fiber-based device, without reliance on free-space optical isolators, circulators, sensors, or active shutdown circuitry.

### BACKGROUND

High power fiber lasers have received a wide attention in the past ten years. Such lasers

with several kilowatts (kWs) or several tens of kWs have been used as commercially available products in industries. In comparison with solid-state lasers, fiber lasers have a unique feature of a superb beam quality at high power due to an all-fiber configuration. That is, all the optical components used in the fiber lasers are of an optical fiber type and are connected using fusion splices without air interfaces between any two of the optical components in connection. The optical components comprise multiple diode laser pumps with multiple optical fiber pigtails, a rare-earth-doped optical fiber with two fiber Bragg gratings, a delivery fiber spliced to the rare-earth-doped optical fiber for a fiber laser output, and a signal-and-pump combiner with multiple input multimode fibers to splice to the multiple optical fiber pigtails of the multiple diode laser pumps and with a length of double-clad fiber (DCF) to splice to the rare-earth-doped optical fiber for a pump input. The rare-earth-doped optical fiber, doped with a rare earth element such as erbium (Er) or ytterbium (Yb) as a gain medium, provides for a beneficial geometry and a large surface to volume ratio, thus allowing for extraordinary heat dispersion and reducing thermal lensing effect when compared to rod type solid state lasers. The rare-earth-doped optical fiber with the gain medium receives and absorbs optical energy from the multiple diode laser pumps through the signal-and-pump combiner and creates a coherent laser light via a resonator built by using the two fiber Bragg gratings at two ends of the rare-earth-doped optical fiber. Such multimode fiber lasers in the 2-to 6-kW regime are ideal for cutting and welding, and particularly in an area of materials processing and laser machining as a reliable replacement for bulky diode pumped solid-state lasers and CO₂ lasers. It has been shown that lengthening the rare-earth-doped optical fiber can inherently increase power of the fiber lasers without a limit if a large mode area of DCF is used. However, DCFs used in both the length of DCF of the signal-and-pump combiner and the rare-earth-doped optical fiber are surrounded by polymer coatings with a limited tolerance to heat. In other words, the maximum thermal load provided by the polymer coatings dictates the maximum output power that the fiber laser can attain.

Not similar to optical fibers used in optical communications, where the coatings outside the optical fibers simply play a role of mechanical protection, the polymer coatings used in DCFs, however, perform mechanical and optical functions. DCFs use dual acrylate coatings, with a first low refractive index polymer coating in contact with the glass, and with a durable second coating to protect the first relatively soft low refractive index coating. In other words, the second coating mechanically protects the low refractive index coating from mechanical chips, cuts, or scratches which may result in optical energy to leak out from the optical fiber, possibly creating localized hot spots or catastrophic burns at high pump powers. DCFs with the dual acrylate coating can pass the stringent reliability test specified by Telcodia GR-20 standard used in the telecom industry.

An N×1 tapered fiber bundle (TFB) is used to combine multiple (“N”) inputs from multimode fiber pigtails connecting to multiple pump diodes into a single output, so called an end-pumped combiner. The “N” satisfies the brightness conservation theorem, and the maximum “N” is 6, 13, 17, 24, 53, 63, 136, etc., depending on various combinations of various diameter and numerical aperture (NA) of the input optical fibers (i.e., the multiple multimode fibers) and the output optical fiber. In practice, the N is chosen to be far smaller than the maximum numbers specified above to provide some margin. The N×1 TFB is typically fabricated in a process similar to fused fiber couplers by bundling in parallel N multimode optical fibers that have been stripped of their polymer coatings. The N multimode optical fibers are then fused and tapered by heating with a flame such as electric arc, oxyhydrogen flame, or a CO₂ laser beam. A fused and tapered section is then cleaved in the middle and spliced to a single output fiber. The use of N×1 TFB to combine multiple laser diode pumps into one fiber is essential for pumping the fiber lasers. For a 7×1 TFB, each of seven input optical fibers with 200-μm diameter and 0.22-NA receives, for example, 200 W from each diode laser pump. Seven such laser pumps are combined into a single 400-μm double-clad fiber with 0.46-NA. This configuration gives a pumping module composed of active and passive components, delivering 1.4 kWs power for a fiber laser, based on the commercially available 200-W laser diode pumps. For more examples, with a Yb-doped fiber of 400-μm and 0.46-NA, a common TFB coupling six 200-μm 0.22-NA pump delivery fibers each with a pump power of 500 W provides a total power greater than 3 kWs. Using a 19×l TFB and greater than 100-W pump power delivered in each 105-μm input optical fiber, a total of about 2-kW pump power can be achieved.

TFB can also be used in optical fiber amplifiers to combine pump and signal light that is confined to the core of a double-clad fiber. In this case, the fiber in the center of the tapered fiber bundle is replaced by the double-clad fiber with the core carrying an amplifier seed. This is commonly referred to as an (N+1)×1 combiner, which is critical for the optical fiber amplifiers or fiber lasers. As an example, a (6+1)×1 combiner accommodating six pump fibers and the double-clad fiber as a signal fiber can be used for a 1 kW co-pumped optical fiber amplifier, based on six pump diodes each delivering, for example, 250 W of pump power for a total pump power of 1.5 kWs. No matter whether 7×1 or (6 +1)×1, the signal-and-pump combiner needs to be thermally managed to maintain its reliability. Specifically, the residual pump power, amplified spontaneous emission (ASE) power, and unwanted signal power trapped in an outer cladding of the double-clad fiber in the fiber lasers or the optical fiber amplifiers need to be removed to avoid potential damages to components downstream. The residual pump power can be in hundreds of watts in kW fiber lasers and the ASE can be in the range of many watts, typically much higher in the optical fiber amplifiers. The unwanted energy launching into the outer cladding of the double-clad fiber creates localized hot spots or catastrophic burns at high pump powers. The most efficient way to remove the cladding light is to strip the low-index fluoroacrylic coating off a length of the fiber and re-coat it with a high-index coating so that high-NA cladding light can be stripped.

A conventional signal-and-pump combiner is based on an end-pump technology and is basically an (N+1)×1 TFB pump combiner. The (N+1)×1 TFB pump combiner is a hexagonally packed fiber bundle fused and tapered for stability and high packing density. The resulting cross section of the hexagonally stacked bundle is close to a circle, and thus eases splicing with the output optical fiber. However, in making TFB, the signal fiber in a central position is tapered, twisted, and fused with “N” pump fibers. The signal fiber is significantly affected, resulting in an optical loss and beam quality degradation for a signal light. A splicing loss may be high due to a mode-field-diameter mismatch between the TFB and a rare-earth-doped double-clad fiber in applications of the optical fiber lasers and the optical fiber amplifiers.

With the emergence and development of double-clad fibers, large mode area fibers, semiconductor lasers as pumping sources, and cascade-pumping technologies, an output power of the fiber lasers continues to increase. The pumping sources and the resonant cavity with a gain medium are used through fiber fusion-splice processes. The all-fiber structure makes the system more compact and stable with a higher coupling efficiency and better reliability. A high coupling efficiency of an optical fiber signal-and-pump combiner is essential to build the fiber lasers with a high power level because a power carrying capability of such fiber lasers directly relates to the high coupling efficiency, which further determines an output power level of such fiber lasers. Such an optical fiber signal-and-pump combiner adopts a side-pump technology and uses a circumferential side of the double-clad fibers for one or more pump lights with a pump power to launch and couple into an inner cladding of the double-clad fibers without occupying two ends of the double-clad fibers, therefore, not affecting an input and an output of the signal light and its transmission. The main advantage of this technology is that the signal fiber in a central position is not tapered, which can greatly reduce the loss of the signal light, improve the coupling efficiency ensuring good performance, and maintain beam quality to potentially achieve a scheme, arrangement or configuration of multi-point cascade-pumping. Also, not like TFB based on the end-pump technology, the optical fiber signal-and-pump combiner based on the side-pump technology does not need cleaving in the middle of the TFB and splicing to another single output fiber. Furthermore, the double-clad fibers used in the optical fiber signal-and-pump combiner match most of rare-earth-doped double-clad fibers in NA and core and cladding diameters without a mode-field-diameter mismatch. Such features cannot be achieved using the end-pump technology of TFB mentioned above.

A side-pump based optical fiber signal-and-pump combiner with high reliability and good stability is of great significance for constructing fiber laser systems with a high power and a high beam quality because it can support “N” laser pumps launching into the (N+1)×1 optical fiber signal-and-pump combiner with all the signal and the pump power outputted from the one signal fiber to achieve a high output power. In reported all-fiber structures, the side-pump based signal-and-pump combiner is made by a fiber tapering and fusion method in which the tapered pumping fiber is directly fused with the inner cladding of the signal fiber, so called a side coupler, achieving higher pumping coupling efficiency and a power carrying capability of kilowatts of pumping power. Therefore, this technology has become a mainstream for making a high-power side-pump based optical fiber signal-and-pump combiner (side-pumped signal-and-pump combiner, hereinafter). However, the conventional side-pump technology adopted to build such high-power side-pumped signal-and-pump combiners needs the multi-point cascaded-pumping configuration, which introduces an accumulated splice loss and thus does not meet requirements. A reason of using the multi-point cascaded-pumping configuration is that parallel pumping using multiple channels of the signal-and-pump combiner is not commercially available due to production difficulties. Either coupling efficiency is not as high as expected or the overall insertion loss is not low enough, resulting in a low production yield.

Fiber laser systems are widely employed in industrial material-processing applications due to their high electrical-to-optical efficiency, excellent beam quality, and compact form factor. When processing highly reflective materials, such as copper, aluminum, or gold, however, a portion of the incident laser radiation may be reflected back toward the laser sources. Such back-reflected optical radiation can propagate into the laser system and adversely affect system performance, including destabilizing laser operation, inducing damage to pump light sources, or causing degradation or failure of optical components within the system.

In some laser system implementations, mitigation of back-reflected optical radiation is achieved using free-space optical isolators or end-pumped signal-and-pump combiners. These implementations can increase system complexity and cost and may be susceptible to optical misalignment or thermal effects at high output power levels. There therefore remains a need for an all-fiber laser architecture that inherently suppresses back-reflected optical radiation while maintaining high-power scalability and reliability. The present disclosure addresses these and other considerations by providing structures and features for an all-fiber laser system suitable for industrial material-processing applications.

### SUMMARY

The present invention provides an all-fiber laser system incorporating an isolating side-pumped signal-and-pump combiner that structurally isolates pump light sources from back-reflected signal light and backward-propagating SRS light. Pump light is injected laterally into the cladding of a signal fiber while the signal propagates through a core of the fiber, thereby eliminating a direct reverse-propagation path from the workpiece to the pump diodes. The architecture enables stable laser operation during processing of highly reflective materials without requiring free-space optical isolators, improves pump diode lifetime, and allows power scaling beyond kilowatt levels in a compact, robust, all-fiber configuration.

A fiber laser system, after a long period of usage, always shows a compromised laser output power due to aging of laser diodes, a laser cavity, and fiber components, affecting an output beam quality. Therefore, it is essential to provide a real-time monitoring of a fiber laser power at different monitoring locations such as a fiber laser output or an intra-cavity to feedback control and to optimally adjust the fiber laser output power, enhancing quality performance in material processing.

In some fiber laser applications, the seed laser generates signal light at a wavelength in a range of approximately 1030 nm to 1100 nm, the pump light source generates pump light at a wavelength in a range of approximately 915 nm to 976 nm, and SRS light generated in the fiber is red-shifted relative to the signal wavelength, for example into a range above approximately 1100 nm. Because the wavelength of SRS light differs from that of the signal light, suppression of backward-propagating SRS light can be challenging. A side-pumped combiner provides inherent isolation of pump sources with respect to both the signal light and the SRS light.

High-power laser output may comprise strong Stokes scattering. When such Stokes light propagates backward toward a laser cavity, it can be amplified because an ytterbium-doped fiber (YDF) provides a non-negligible emission cross section at wavelengths corresponding to SRS. In practice, damage to pump sources and other optical components is caused not directly by back-reflected optical radiation or backward-propagating SRS light, but rather by laser instability induced thereby.

Laser instability arises when Stokes scattering becomes amplified, resulting in depletion of the excited population and suppression of the primary laser oscillation. As the SRS light subsequently weakens, population inversion rapidly accumulates, after which laser action regenerates with excessive stored energy, frequently leading to self-pulsation. The excited-state lifetime of Yb³⁺ ions is approximately 800 microseconds. As population inversion increases, the self-pulsation frequency may increase, producing pulses with durations as short as about 100 microseconds. In such cases, peak power may reach values on the order of 3 MW, which can significantly exceed a damage threshold of an output fiber.

Back-reflected optical radiation in a fiber laser system may be classified according to wavelength and propagation mode, including radiation at a seed-laser wavelength and radiation at a stimulated Raman scattering (SRS) wavelength, and further including core-guided modes and cladding-guided modes, thereby defining four categories of back-reflected light. A cladding power stripper (CPS) may be employed to remove back-reflected optical energy propagating in cladding-guided modes. The CPS may be disposed downstream of the gain fiber and configured to dissipate cladding-guided optical radiation propagating in at least one of a forward direction or a backward direction along the gain fiber and a signal fiber, while allowing core-guided signal radiation to propagate substantially unaffected. The CPS is non-wavelength-selective and removes optical radiation based on spatial mode confinement rather than wavelength.

A high-reflectivity fiber Bragg grating (HR FBG) may be configured to block back-reflected core-guided light at a seed-laser wavelength while allowing core-guided light at an SRS wavelength to propagate therethrough. In addition, an output fiber having a relatively small core diameter and a low numerical aperture (NA) may be employed to reduce a likelihood of collecting back-reflected optical radiation while still providing near single-mode output with a beam quality factor M² close to 1.2, such that the signal laser beam propagates in a single-mode or few-mode core.

The isolating side-pumped signal-and-pump combiner may further be used to provide intrinsic isolation of one or more pump sources with respect to both signal light and SRS light. In particular, the isolating side-pumped signal-and-pump combiner is configured to prevent direct optical continuity between pump fibers and a signal core. Furthermore, the pump fibers are configured such that back-reflected signal light and backward-propagating SRS light do not satisfy a numerical-aperture or mode-matching condition required for coupling into the pump fibers.

In general, mitigation strategies may include suppressing back-reflected optical radiation, including both signal light and SRS light, at respective generation points; absorbing reflected optical energy; stripping residual reflected optical energy that may reach laser diodes (LDs); controlling nonlinear optical effects by selecting an appropriate length of an output fiber and employing a large-mode-area (LMA) core of a gain fiber to reduce nonlinear effects during high-power operation; and adopting a wavelength-dependent spatial filter configured to spatially deviate back-reflected SRS light from coupling into a core of a signal fiber. For example, back-reflected SRS light propagating in a core may be spatially transferred into cladding modes, with the transferred optical energy absorbed or dissipated by the CPS.

An all-fiber laser system comprises a laser cavity defined by a high-reflectivity fiber Bragg grating (HR FBG) and a low-reflectivity output-coupler fiber Bragg grating (OC FBG), wherein the laser cavity corresponds to a region between the HR FBG and the OC FBG. The all-fiber laser system further comprises a gain fiber including a section of double-clad fiber doped with a gain medium, the gain fiber being optically coupled between the HR FBG and the OC FBG and configured to generate laser radiation within the laser cavity.

The all-fiber laser system further comprises a plurality of diode laser sources, each coupled to a respective pump fiber, the plurality of diode laser sources being configured to collectively provide pump light for energizing the gain fiber. At least one side-pumped signal-and-pump combiner is optically coupled to at least one of the HR FBG or the OC FBG to introduce pump light into the gain fiber. A forward-pumping, backward-pumping, or bidirectional-pumping scheme may be employed to deliver high pump power while mitigating excess heat generation at the at least one side-pumped signal-and-pump combiner.

The all-fiber laser system further comprises an endcap optically coupled to an output fiber, the endcap being configured to deliver the laser radiation to a workpiece at a focal point or, in some implementations, at a position slightly offset from the focal point in order to reduce optical reflection from a highly reflective workpiece. The all-fiber laser system may further comprise a cladding power stripper (CPS) disposed downstream of the gain fiber and configured to remove unabsorbed residual pump light propagating in cladding-guided modes of the output fiber, thereby maintaining beam quality of the laser radiation. In addition, the CPS may be configured to dissipate backward-propagating cladding-guided radiation, including backward-propagating SRS light that has coupled into cladding modes.

The length of double-clad fiber in the at least one isolating side-pumped signal-and-pump combiner comprises a first core, a first cladding, and a second cladding over the first cladding and is configured to transport an optical signal in the first core with the optical signal bounded in a first interface between the first core and the first cladding. The length of double-clad fiber further comprises a cladding-stripped portion comprising a coupling portion. A combined optical energy propagates in the length of double-clad fiber and is bounded in a second interface between the first cladding and the air around the cladding-stripped portion. Each of the one or more multimode fibers respectively comprises a second core, a third cladding, and outer claddings and buffer coatings over the third cladding. Each of the one or more multimode fibers further comprises a stripped portion with the outer claddings and buffer coatings stripped. A part of the stripped portion is configured to be pre-heated and stretched into a taper portion with a predetermined taper slope with respect to an optical axis of each of the one or more multimode fibers. A plurality of the taper portions formed in the one or more multimode fibers are configured to be further fused around the coupling portion with the third cladding directly coupled with the first cladding. Each of the one or more multimode fibers is configured to respectively inject a part of the combined optical energy into the first cladding for lateral coupling.

### BRIEF DESCRIPTION OF THE DRAWINGS

The following description sets forth exemplary, non-limiting embodiments of the present disclosure with reference to the accompanying drawings. Like reference numerals designate like elements throughout the drawings unless otherwise expressly stated. As used herein, the terms “first,” “second,” and the like are employed solely for purposes of reference and distinction between elements, and do not imply any particular order, sequence, or relative importance unless explicitly recited in the claims.

FIG. 1 is a schematic diagram illustrating an all-fiber laser system according to a first embodiment of the present disclosure.

FIG. 2 is a perspective view illustrating structural features of an isolating side-pumped signal-and-pump combiner incorporated into the all-fiber laser system of FIG. 1, according to the first embodiment of the present disclosure.

FIG. 3 is a schematic diagram illustrating signal propagation and pump coupling mechanisms within the isolating side-pumped signal-and-pump combiner of FIG. 2, according to the first embodiment of the present disclosure.

FIG. 4 is a schematic diagram illustrating suppression paths for back-reflected optical radiation generated during processing of a reflective workpiece, as implemented in the all-fiber laser system according to the first embodiment of the present disclosure.

FIG. 5 is a schematic diagram illustrating a protective system shutdown mechanism configured to respond to excessive back-reflected optical radiation, according to a second embodiment of the present disclosure.

FIG. 6 is a flowchart illustrating a protective system shutdown control algorithm executed by the all-fiber laser system according to the second embodiment of the present disclosure.

FIG. 7 is a schematic diagram illustrating an alternative protective system shutdown mechanism configured to respond to excessive back-reflected optical radiation, according to the second embodiment of the present disclosure.

FIG. 8 is a schematic diagram illustrating an experimental stress-simulation test configuration for characterizing isolation performance of signal-and-pump combiners according to the present disclosure.

FIG. 9 is a schematic diagram illustrating an all-fiber laser system according to a third embodiment of the present disclosure.

### DETAILED DESCRIPTION OF VARIOUS EMBODIMENTS

Reference will now be made in detail to the preferred embodiments of the present disclosure. Wherever possible, the same or similar reference numerals are used throughout the drawings and the description to refer to the same or like elements or steps. The drawings are provided in simplified schematic form and are not necessarily drawn to scale.

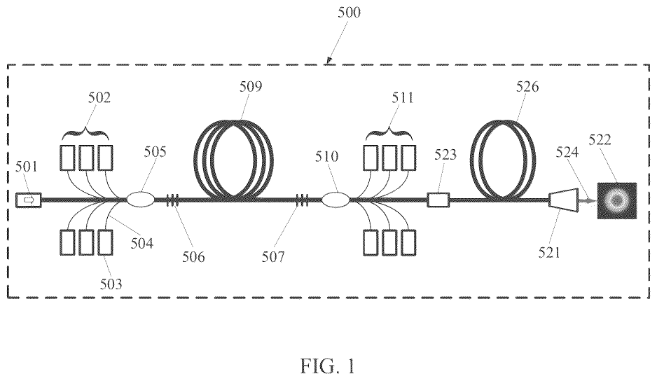

FIG. 1 is a schematic diagram of an all-fiber laser system according to a first embodiment of the present invention. In FIG. 1, the all-fiber laser system 500 comprises a seed laser 501, pump sources 502 and 511, at least one isolating side-pumped signal-and-pump combiner 505 and 510, a gain fiber 509, and an output fiber 526. The all-fiber laser system 500 further comprises a laser cavity between a high-reflector fiber-Bragg grating (HR FBG) 506 and a low-reflectivity output coupler FBG (OC FBG) 507. The gain fiber 509 comprises a first length of double-clad fiber doped with Yb³⁺ ion and is disposed in the laser cavity. The gain fiber 509 is configured to produce the fiber laser light via the laser cavity. The pump sources 502 and 511 are configured to provide a portion of a combined optical energy for pumping the gain fiber 509. Each pump source comprises a laser diode (LD) and a section of pump feeding fiber (simply, a pump fiber section spliced with a multimode fiber in the isolating side-pumped signal-and-pump combiner). For example, the pump source 503 comprises an LD and the pump fiber section 504. The at least one isolating side-pumped signal-and-pump combiner 505 and 510 are respectively coupled with the HR FBG 506 and the OC FBG 507. A bidirectional-pump scheme, arrangement or configuration is adopted to provide a high pump power and to avoid excess heat at either of the at least one isolating side-pumped signal-and-pump combiner 505 and 510. The all-fiber laser system 500 further comprises the endcap 521 configured to output the fiber laser light 524 via the delivery fiber 526 (simply, the output fiber 526) to the workpiece at the focal point where the beam profile 522 is displayed. The output fiber 526 represents a portion of an output fiber routed to indicate an extended fiber length. In high-power laser applications, such extended output fiber can provide increased routing flexibility; however, longer fiber lengths may give rise to nonlinear optical effects that can impact system performance. In the present configuration, however, because the at least one isolating side-pumped signal-and-pump combiner 505 and 510 are employed to suppress backward-propagating optical radiation, the occurrence of nonlinear optical effects is mitigated even with a long output fiber 526. The all-fiber laser system 500 may further comprise the cladding power stripper 523 configured to remove any residual power including backward-propagating signal light and SRS light trapped in the cladding of the output fiber 526 and to maintain beam quality of the fiber laser light 524.

As illustrated in FIG. 1, the at least one isolating side-pumped signal-and-pump combiner 505 and 510 provides bidirectional pumping for the all-fiber laser system 500 while mitigating excess heat generation at the combiners under high pump power operation. High-power single-mode fiber lasers are highly desirable for material processing due to their near-diffraction-limited beam quality. However, nonlinear effects, such as SRS, may occur in double-clad fibers, particularly at extended fiber lengths, wherein a portion of the fiber laser light 524 is converted to Stokes light, leading to laser instability. Backward-propagating SRS light can also be generated by reflection from the cladding power stripper 523, the endcap 521, or the workpiece in the all-fiber laser system 500. Therefore, effective SRS suppression is critical for stable operation of the all-fiber laser system 500.

One approach to suppress SRS is to employ bidirectional pumping using the at least one isolating side-pumped signal-and-pump combiner 505 and 510. By increasing the ratio of backward pump power relative to forward pump power, the system can maintain the desired output power even when processing highly reflective materials, without inducing instability in the fiber laser light 524. In this configuration, bidirectional pumping effectively suppresses SRS and prevents backward-propagating signal light and SRS light from coupling into the pump diodes, thereby improving thermal performance, reliability, and protecting the pump sources from damage.

As illustrated in FIG. 1, a backward coupling barrier in each isolating side-pumped signal-and-pump combiner 505 and 510 inherently prevents a portion of the fiber laser light reflected from the workpiece and trapped in the cladding from coupling back into the pump fibers, further protecting pump sources 502 and 511. In contrast, conventional end-pumped combiners, such as those based on tapered fiber bundle (TFB) technology, are generally unsuitable for high-power applications because they cannot provide sufficient backward pump isolation or backward signal isolation to adequately protect pump sources from damage.

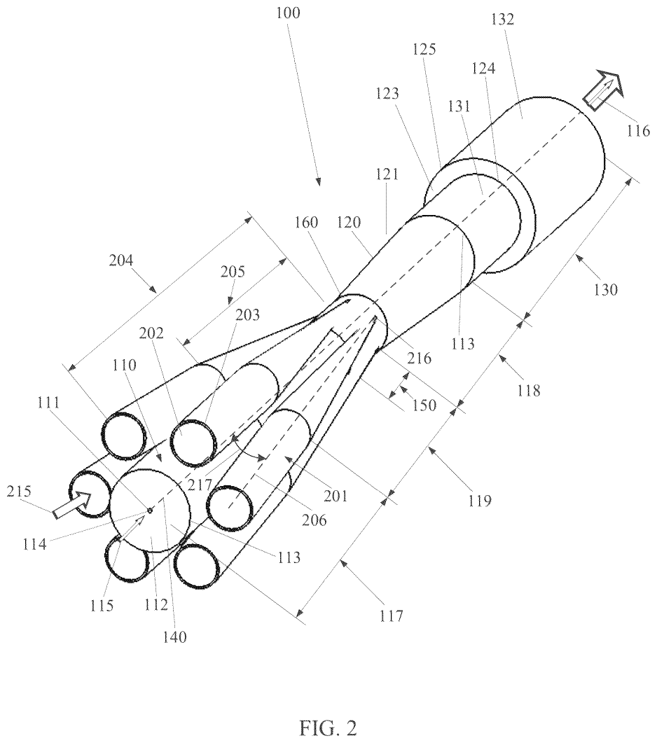

FIG. 2 is a perspective view illustrating structural features of an isolating side-pumped signal-and-pump combiner incorporated into the all-fiber laser system of FIG. 1, according to the first embodiment of the present disclosure.

In FIG. 2, the isolating side-pumped signal-and-pump combiner 100 comprises a signal fiber 110 (simply, a signal fiber 110) and a plurality of multimode fibers 201 each spliced with respective pump fiber section 504 (in FIG. 1). So, the isolating side-pumped signal-and-pump combiner 100 is a (6+1)×1 signal-and-pump combiner. The signal fiber 110 comprises a first core 111, a first cladding 112 with a first diameter 113, a second cladding 123, and an outer polymer coating 125 over the second cladding 123 and is configured to transmit an optical signal in the first core 111 and bounded in a first interface 114 between the first core 111 and the first cladding 112. The optical signal propagates in a forward direction from an input 115 to an output 116 of the signal fiber 110. The signal fiber 110 further comprises a cladding-stripped portion with both the second cladding 123 and the outer polymer coating 125 stripped. The cladding-stripped portion comprises a first portion 117 in proximity to the input 115, a first taper portion 118, and a coupling portion 119 coupling between the first portion 117 and the first taper portion 118. The first taper portion 118 comprises cross sections with their diameters progressively reduced from the first diameter 113 to a first small taper end in a backward direction. The coupling portion 119 comprises a power transfer region 150.

In FIG. 2, each of the plurality of multimode fibers 201 comprises a second core 202, a third cladding 203, outer claddings and buffer coatings (not shown) over the third cladding 203, and a second portion 204 with the outer claddings and buffer coatings stripped. A part of the second portion 204 is configured to be heated and stretched into a second taper in a second taper portion 205 with a first predetermined taper slope with respect to an optical axis 206, for example, of each of the plurality of multimode fibers 201. The second taper in the second taper portion 205 is configured to be fused around the coupling portion 119 with a second small taper end in the power transfer region 150. The plurality of multimode fibers 201 are configured to carry a portion of a combined optical energy and to couple thereof to the signal fiber 110, continuing to be guided in the first cladding 112 and bounded in a second interface 120 between the first cladding 112 and air 121 in the first taper portion 118. The portion of the combined optical energy comes from the multiple laser diode pumps with multiple optical fiber pigtails (simply, pump fibers). In the present disclosure, the combined optical energy is used to represent all the pump energy whereas each of at least one isolating side-pumped signal-and-pump combiner 505 and 510 provides a portion of the combined optical energy. In FIG. 2, a part of the combined optical energy is inputted from a pump input 215. The first predetermined taper slope has a negative sign in a forward direction from the pump input 215 to the second small taper end of the second taper portion 205, meaning that the second taper portion 205 has cross sections with their diameters progressively reduced in the forward direction from a diameter of the third cladding 203 to the second small taper end. The portion of the combined optical energy is transferred from the plurality of multimode fibers 201 to the signal fiber 110 via the power transfer region 150.

In FIG. 2, the signal fiber 110 further comprises a third portion 130 comprising an intermediate section 131 with both the second cladding 123 and the outer polymer coating 125 stripped and an output section 132 in proximity to the output 116. The third portion 130 is configured to connect the intermediate section 131 to the first taper portion 118 and to output both the optical signal and the portion of the combined optical energy coupled. The intermediate section 131 may be omitted. In that case, the third portion 130 is configured to couple the output section 132 to the first taper portion 118 and to output both the optical signal and the portion of the combined optical energy coupled. The portion of the combined optical energy coupled is guided in the first cladding 112 and bounded by a third interface 124 between the first cladding 112 and the second cladding 123 in the output section 132 if the larger divergence of the higher-order modes of the portion of the combined optical energy coupled in the output section 132 is less than the second maximum acceptance angle determined by a second numerical aperture further dictated by refractive indices of the first cladding 112 and the second cladding 123.

In FIG. 2, the portion of the combined optical energy is coupled into the plurality of multimode fibers 201 each at an incident angle against the optical axis 206 of an associated multimode fiber less than the first maximum acceptance angle determined by the first NA of each of the plurality of multimode fibers 201. The portion of the combined optical energy incident slightly less than the first maximum acceptance angle is reflected in the second taper portion 205 with a divergence angle against the optical axis 206 of the associated multimode fiber larger than the incident angle with higher-order modes generated. The higher-order modes lead to larger divergence. Without properly being taken care of, the larger divergence could result in a power loss, creating localized hot spots in the output section 132 and causing burning damages. On the other hand, the first taper portion 118 in the signal fiber 110 is configured to reduce the larger divergence of the higher-order modes, thereby preserving some of the higher-order modes bounded in the second interface 120 to be continuously bounded in the third interface 124 and increasing a coupling efficiency of the combined optical energy coupled from the plurality of multimode fibers 201 to the signal fiber 110.

In FIG. 2, the first taper portion 118 comprises a second predetermined taper slope configured to partially compensate the larger divergence of the higher-order modes in the second taper portion 205 and to minimize a number of the higher-order modes to launch in the third portion 130 and to leak from the third interface 124, resulting in an energy loss, creating localized hot spots, causing failures, and reducing power carrying capability of the isolating side-pumped signal-and-pump combiner 100. The second predetermined taper slope has an opposite sign to the first predetermined taper slope (i.e., a positive sign) in a forward direction from the signal input 115 to an end of the first taper portion 118, meaning that the first taper portion 118 comprises cross sections with their diameters progressively reduced from the first diameter 113 to a predetermined diameter in a backward direction, as mentioned. The power transfer region 150 is configured for the combined optical energy to transfer power from the plurality of multimode fibers 201 to the signal fiber 110. The first taper portion 118 further comprises a first small taper end in proximity to the power transfer region 150, whereas each of the plurality of second taper portions 205 further comprises a second small taper end.

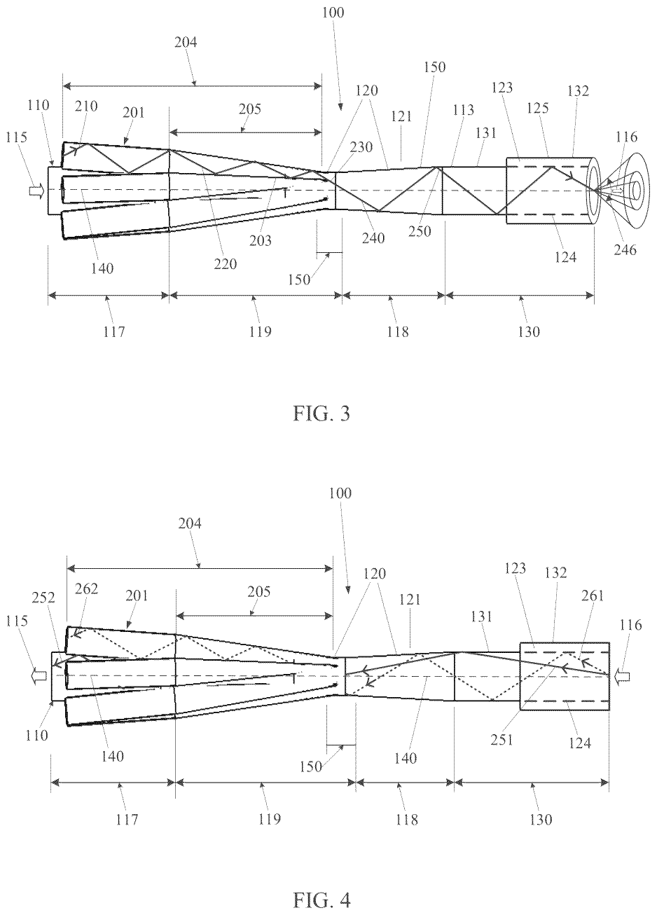

FIG. 3 is a schematic diagram illustrating signal propagation and pump coupling mechanisms within the isolating side-pumped signal-and-pump combiner of FIG. 2, according to the first embodiment of the present disclosure. As shown in FIG. 3, a right-side view of the isolating side-pumped signal-and-pump combiner 100 is illustrated together with an exemplary schematic of pump light launched into, and reflected within, the isolating side-pumped signal-and-pump combiner 100. Although not visible in FIG. 3, the third cladding 203 of each of the plurality of multimode fibers 201 is present, indicating that each of the plurality of multimode fibers 201 is not coreless and that no intermediate fiber is employed.

Referring to FIG. 2 and FIG. 3, each of the plurality of second taper portions 205 is fused around the coupling portion 119 at an inclined angle 217 (shown in FIG. 2). Also illustrated is an example of a meridional ray that passes through an optical axis 206 (FIG. 2) of each of the plurality of multimode fibers 201 and satisfies a self-interference condition. In particular, the meridional ray intersects the optical axis 206 at each internal reflection.

In FIG. 3, a light ray 210 is incident at an angle slightly less than a first maximum acceptance angle defined by a first numerical aperture (NA) of each of the plurality of multimode fibers 201. When the light ray 210 propagates through each of the plurality of second taper portions 205, higher-order modes are generated as a divergence angle relative to the optical axis 206 increases with successive internal reflections. Accordingly, generation of higher-order modes results in increased beam divergence. The higher-order modes, represented by a first light ray 220, are launched into the coupling portion 119, and the divergence angle of the first light ray 220 progressively increases through the plurality of second taper portions 205 with additional internal reflections.

Pump power transferred during a power-transfer process initially undergoes an adiabatic transfer from the second core 202 to an interface between the third cladding 203 and air 121. The pump power is then coupled into adjacent cladding modes bounded by a second interface 120 between the first cladding 112 and air 121 within the first taper portion 118 and an intermediate section 131 (shown in FIG. 2), and is finally confined by a third interface 124 between the first cladding 112 and a second cladding 123 in an output section 132.

Each of the plurality of multimode fibers 201 has a numerical aperture of approximately 0.22 (i.e., 0.22-NA). In this manner, the plurality of second taper portions 205 are configured to increase beam divergence of the higher-order modes such that pump power is transferred to adjacent cladding modes bounded by the second interface 120 between the first cladding 112 and air 121. Without the first taper portion 118, the increased divergence of the higher-order modes would be maintained throughout a third portion 130 in accordance with principles of total internal reflection in optical fibers.

The signal fiber 110 according to the present disclosure has a numerical aperture of approximately 0.46 (i.e., 0.46-NA). For higher-order modes that are not guided by the 0.46-NA of the signal fiber 110, a portion of the combined optical energy may leak through the third interface 124 between the first cladding 112 and the second cladding 123 into an outer polymer coating 125, where the leaked optical energy is converted into heat and accumulates in the output section 132, potentially resulting in premature failure or thermal damage.

As shown in FIG. 3, when a divergence of higher-order modes exceeds a first maximum acceptance angle determined by a first numerical aperture (NA) of each of the plurality of multimode fibers 201, the first light ray 220 transitions into a second light ray 230 and propagates as a first cladding mode of the plurality of multimode fibers 201. The plurality of second taper portions 205 are fused to the first cladding 112 of the signal fiber 110. Because a refractive index of the first cladding 112 is greater than that of the second core 202 of the plurality of multimode fibers 201, the first cladding mode is coupled into the signal fiber 110 within the power transfer region 150 and is further confined by the second interface 120, thereby completing a power-transfer process in the coupling portion 119.

For light rays having a divergence of higher-order modes that does not satisfy a second maximum acceptance angle determined by a second NA of the signal fiber 110, a portion of the coupled optical energy leaks into air 121. For example, a third light ray 240 having a divergence of higher-order modes that satisfies the second maximum acceptance angle of the signal fiber 110 within the first taper portion 118 is guided along the second interface 120 in the first taper portion 118. Accordingly, the first taper portion 118 is configured to reduce the divergence of higher-order modes, such as the third light ray 240.

As illustrated, the divergence of the higher-order modes progressively decreases within the first taper portion 118, resulting in a fourth light ray 250 at an end of the first taper portion 118, which continues propagating through the intermediate section 131. The fourth light ray 250, having a reduced divergence, propagates to the output 116 of the signal fiber 110. As described above, the output 116 of the signal fiber 110, corresponding to an output of the optical signal, also serves as an output 245 of the coupled pump light. The coupled pump light exits with a beam divergence 246, a half-angle of which is smaller than a divergence angle of the second light ray 230.

Not all light rays can be effectively coupled into and guided by the signal fiber 110, particularly when the first taper portion 118 is absent. In such a case, the second light ray 230 may be directly coupled into the third portion 130 with a relatively large divergence of higher-order modes, which may exceed the second maximum acceptance angle determined by the second NA of the signal fiber 110, as dictated by refractive indices of the first cladding 112 and the second cladding 123. Portions of the second light ray 230 that exceed the second maximum acceptance angle may leak from the second cladding 123 into an outer polymer coating 125, where the leaked optical energy is converted into heat and accumulates in the output section 132. Such heat accumulation may cause a significant temperature rise in the outer polymer coating 125 and can lead to irreversible thermal damage when the coupled optical energy is sufficiently high. The generated heat also limits a maximum power-handling capability of the isolating side-pumped signal-and-pump combiner 100.

The first taper portion 118 comprises a second predetermined taper slope configured to partially compensate for the increased divergence of higher-order modes generated in the plurality of second taper portions 205, to reduce a number of higher-order modes launched into the third portion 130, and to suppress leakage from the third interface 124, thereby reducing optical losses and a number of localized hot spots in the output section 132. Such localized hot spots in the outer polymer coating 125 can lead to reliability concerns and potential failures, further limiting power-carrying capability of the isolating side-pumped signal-and-pump combiner 100. In other words, with the first taper portion 118 in place, increased divergence of higher-order modes generated in the plurality of second taper portions 205 can be at least partially compensated, such that some higher-order modes that would otherwise not be supported by the 0.46-NA of the signal fiber 110 are guided without leaking into the outer polymer coating 125.

The isolating side-pumped signal-and-pump combiner 100 inherently provides higher backward pump isolation and higher backward signal isolation than an end-pumped pump combiner. As described above, each of the plurality of multimode fibers 201 includes the third cladding 203 in the second taper portion 205, which is wrapped around the first cladding 112 of the signal fiber 110, such that the third cladding 203 is in direct contact with the first cladding 112. The first cladding 112 has a refractive index greater than a refractive index of the third cladding 203, thereby forming a backward-coupling barrier for optical radiation reflected in both forward and backward directions. Such reflected optical radiation may include portions of the combined optical energy, portions of the input optical signal, and portions of fiber laser light having relatively small propagation angles. When such reflected optical radiation reaches the coupling portion 119, it is continuously confined at a third interface formed between the first cladding 112 and the third cladding 203, thereby significantly suppressing coupling of the reflected optical radiation into both the plurality of multimode fibers 110 and a plurality of pump-feeding fiber sections 504, and thus increasing backward pump isolation and backward signal isolation.

FIG. 4 is a schematic diagram illustrating suppression paths for back-reflected optical radiation generated during processing of a reflective workpiece, as implemented in the all-fiber laser system according to the first embodiment of the present disclosure. Referring to FIG. 1, a part of residual pump light can launch a second isolating side-pumped signal-and-pump combiner 510 from a first isolating side-pumped signal-and-pump combiner 505. A part of an optical signal and a part of the fiber laser light can leak into the second isolating side-pumped signal-and-pump combiner 510 and couple into the second set of the plurality of laser diodes 511 possibly damaging thereof, depending on how high the backward pump isolation and the backward signal isolation provided by the second isolating side-pumped signal-and-pump combiner 510. Similarly, the back reflected laser light from the optics downstream such as the endcap 521 and the workpiece, and a part of the fiber laser light can launch into the first isolating side-pumped signal-and-pump combiner 505. The optical energy can leak into the first isolating side-pumped signal-and-pump combiner 505 and couple into the first set of the plurality of laser diodes 502 possibly damaging thereof, depending on how high the backward pump isolation and the backward signal isolation provided by the first isolating side-pumped signal-and-pump combiner 505. FIG. 4 illustrates exemplary suppression paths that, by virtue of structural configuration, inhibit coupling of backward-propagating signal light and SRS light into pump fibers, thereby providing intrinsic optical isolation of pump light sources. As shown in FIG. 4, a fifth light ray 251 comprising low-order modes launched from the “input” 116 (i.e., the output in FIG. 3) into the signal fiber 110 is blocked within the power transfer region 150, such that the fifth light ray 251 is inhibited from propagating toward the plurality of multimode fibers 201 and the pump sources.

According to experimental results, the isolating side-pumped signal-and-pump combiner is capable of substantially suppressing coupling of low-order modes into each of the plurality of multimode fibers 201. Instead, a sixth light ray 252 comprising low-order modes exits the signal fiber 110, with most of its optical energy being delivered to the “output” 115 (i.e., the input in FIG. 3).

For higher-order modes, such as a seventh light ray 261, partial coupling into each of the plurality of multimode fibers 201 may occur. As described above, the first cladding 112 has a second refractive index greater than a first refractive index of the third cladding 203, thereby forming a backward-coupling barrier that inhibits most optical energy reflected within the signal fiber 110 from coupling into the plurality of multimode fibers 201.

That is, when optical energy propagating in either a forward direction or a backward direction reaches the coupling portion 119, most of the optical energy is continuously confined at a third interface formed between the first cladding 112 and the third cladding 203, thereby significantly suppressing coupling of the optical energy back into both the plurality of multimode fibers 201 and the plurality of pump fiber sections 504 (shown in FIG. 1). As a result, both backward pump isolation and backward signal isolation contribute to preventing damage to the plurality of laser diodes. As illustrated in FIG. 4, an eighth light ray 262 exits the plurality of multimode fibers 201 with its optical energy being substantially suppressed.

From another perspective, an acceptance cone of a pump fiber is determined by both numerical aperture (NA) and core diameter, wherein the NA corresponds to angular acceptance and the core diameter corresponds to spatial acceptance. For backward-propagating signal light or SRS light to couple into a pump fiber, such light must enter the pump fiber within an acceptance angle defined by the NA and must spatially overlap with the pump fiber core. The isolating side-pumped signal-and-pump combiner recited in the present disclosure is configured to intentionally violate one or both of these coupling conditions, thereby providing inherent isolation of the pump sources.

FIG. 5 is a schematic diagram illustrating a protective system shutdown mechanism configured to respond to excessive back-reflected optical radiation, according to a second embodiment of the present disclosure. FIG. 5 is generally similar to FIG. 1, except that a tap monitor 600 is incorporated to monitor optical radiation backward-propagating through the output path. As shown, the tap monitor 600 is disposed between a cladding power stripper 523 and an output fiber 526. An upstream port 208 of the tap monitor 600 is configured to detect backward-propagating optical radiation reflected from a reflective workpiece located at a position 522 and to provide a corresponding back-reflection monitoring signal. A downstream port 209 of the tap monitor 600 is configured to monitor forward-propagating optical radiation.

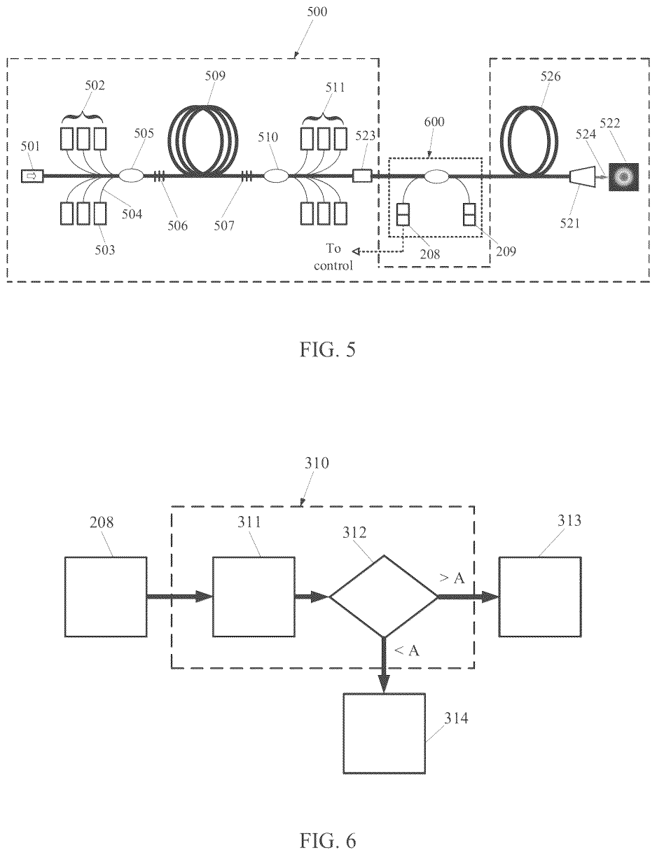

FIG. 6 is a flowchart illustrating a protective system shutdown control algorithm executed by the all-fiber laser system according to the second embodiment of the present disclosure. As shown in FIG. 6, a back-reflection monitoring signal output from an upstream port 208 of a tap monitor 600 is provided to a processing unit 310 that includes a signal integration unit 311 and a decision unit 312. The signal integration unit 311 is configured to integrate the monitoring signal over time, and the decision unit 312 evaluates whether backward-propagating optical radiation exceeds a predetermined threshold “A”. When the threshold is exceeded, a shutdown process 313 is initiated to protect the all-fiber laser system; otherwise, normal laser operation is maintained at step 314. Under conditions in which the same pump sources and isolating side-pumped signal-and-pump combiners are used, the predetermined threshold “A” can be increased by up to five times relative to an end-pumped combiner, thereby enabling continuous operation without interruption even when subjected to strong back-reflected optical radiation. In such configurations, the all-fiber laser system may be operated in a continuous-wave (CW) mode or a modulated CW mode for welding or cutting reflective metals. In the experiment, the at least one pump light source comprises one or more 500-watt-class laser diodes directly coupled to respective pump fibers. The at least one pump light source is configured to operate continuously at full rated power for a duration of at least 72 hours while being exposed to back-reflected optical power exceeding 2 kilowatts, without observable degradation in laser output power, spectral characteristics, or beam quality.

The one or more isolating side-pumped signal-and-pump combiners are further configured to support continuous laser operation at output power levels of at least 3 kilowatts without triggering a protective system shutdown during processing of a highly reflective metal, such as copper. During such processing, the one or more isolating side-pumped signal-and-pump combiners provide intrinsic immunity of the at least one pump light source to back-reflected optical radiation generated during high-power interaction with reflective materials. This intrinsic immunity is achieved without the use of optical isolators, circulators, or free-space optical components.

In continuous processing operations, the all-fiber laser system is configured to process copper at normal incidence without initiating protective shutdown or power derating in response to back-reflected optical radiation. Stable laser operation is maintained under directly measured back-reflection conditions generated during material processing.

The one or more isolating side-pumped signal-and-pump combiners are further configured to suppress optical self-pulsation induced by backward-propagating optical radiation, including SRS light amplified within the gain fiber, and to prevent backward-propagating SRS light from causing rapid collapse of population inversion in the gain medium. Suppression of backward-propagating SRS light limits peak optical power generated by self-pulsation within the output fiber to a level below a damage threshold of the output fiber, thereby protecting the output fiber from peak optical powers such as exceeding 1 megawatt and preventing catastrophic optical damage (COD). In particular, the one or more isolating side-pumped signal-and-pump combiners are configured to prevent generation of optical self-pulsation having peak power levels of 3 megawatts or greater.

FIG. 7 is a schematic diagram illustrating an alternative protective system shutdown mechanism configured to respond to excessive back-reflected optical radiation, according to the second embodiment of the present disclosure. FIG. 7 is generally similar to FIG. 5, except that a photodetector 620 is provided in place of the tap monitor 600 at a location 207. As shown, the photodetector 620 is positioned to receive optical radiation escaping from a fiber surface and is configured to generate a corresponding monitoring signal indicative of back-reflected optical radiation. The monitoring signal is supplied to the processing unit 311 (in FIG. 6) for evaluating whether a protective shutdown condition is satisfied. Such a configuration is particularly suitable for industrial laser processing applications, as it enables timely detection of excessive back-reflected optical radiation while reducing unnecessary system interruptions. In some embodiments, the all-fiber laser system incorporating isolating side-pumped combiners is configured to continue operating in the presence of back-reflected optical radiation below a predetermined threshold, thereby improving operational stability compared with systems that shut down in response to transient reflections, such as certain laser systems that may shut down at intervals of approximately 3 to 8 minutes when processing highly reflective materials.

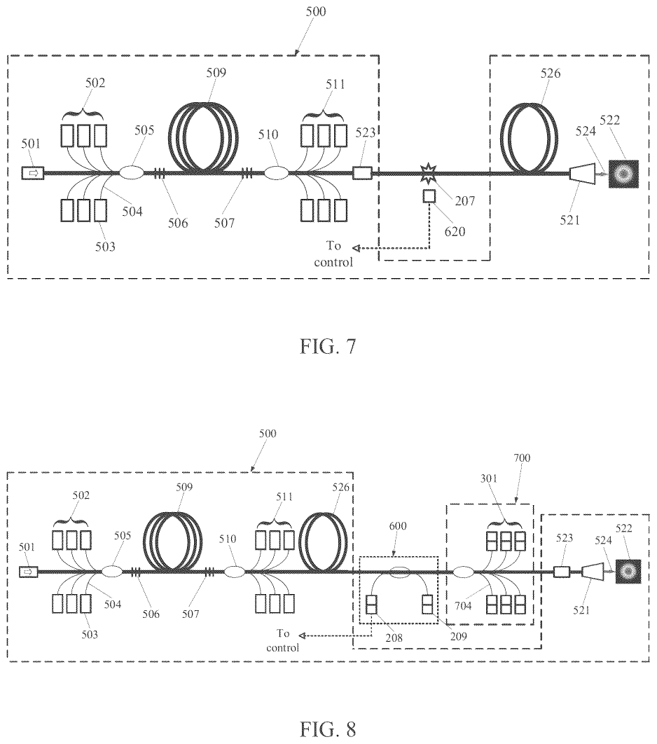

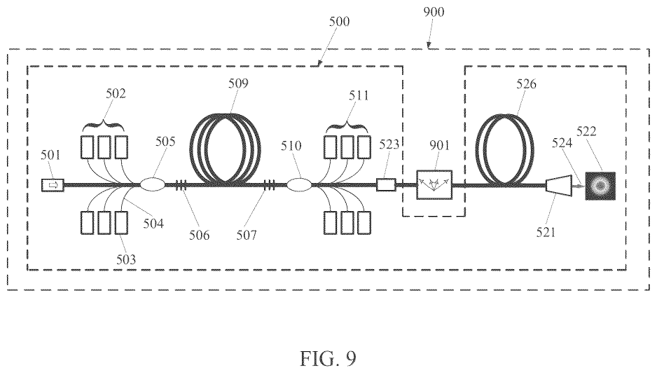

FIG. 8 is a schematic diagram illustrating an experimental stress-simulation test configuration for characterizing isolation performance of an isolating side-pumped signal-and-pump combiner according to the present disclosure. FIG. 8 is generally similar to FIG. 5, except that an isolating side-pumped signal-and-pump combiner 700 under test is positioned proximate to a laser output end such that respective pump fiber sections 704 are accessible for measurement of output power, each pump fiber section 704 being coupled to a corresponding power meter 301, and further except that a portion of an output fiber 526 is routed upstream of the tap monitor 600 for test and observation purposes. In the configuration of FIG. 8, the all-fiber laser system 500 is operated as a controlled high-power laser source. The experimental stress-simulation test setup is configured to introduce controlled back-reflected optical power and backward-propagating SRS light in order to characterize isolation performance of the isolating side-pumped signal-and-pump combiner 700 under test in comparison with an end-pumped combiner. In representative test results, the isolating side-pumped signal-and-pump combiner 700 under test exhibits a reduction in leakage of at least approximately 7 dB, averaged over back-reflected signal light and backward-propagating SRS light, relative to the end-pumped combiner. That is, the one or more isolating side-pumped signal-and-pump combiners are configured to reduce leakage of back-reflected optical power into the pump fibers by at least 5 dB relative to an end-pumped signal-and-pump combiner under otherwise identical operating conditions.

In the experimental stress-simulation test configuration of FIG. 8, controlled back-reflected optical radiation is introduced into an output path of the all-fiber laser system 500 to simulate reflection conditions encountered during processing of highly reflective materials. Backward-propagating SRS light is generated under controlled operating conditions of a high-power laser source.

Optical power coupled into respective pump fiber sections 704 is monitored, the pump fiber sections 704 being configured such that back-reflected signal light and backward-propagating SRS light do not satisfy numerical-aperture or mode-matching conditions required for coupling into the one or more pump fibers. Optical power coupled into the pump fiber sections 704 is measured using corresponding power meters 301 to quantify leakage associated with backward-propagating optical radiation.

Isolation performance is characterized by comparing measured leakage levels obtained using the isolating side-pumped signal-and-pump combiner 700 under test with leakage levels obtained using an end-pumped combiner under substantially similar test conditions. Averaged leakage-reduction values may be calculated over multiple operating points and optical-radiation components to evaluate comparative isolation performance.

FIG. 9 is a schematic diagram illustrating an all-fiber laser system according to a third embodiment of the present disclosure. The configuration of FIG. 9 is generally similar to that of FIG. 1, except that a wavelength-dependent spatial filter 901 is disposed between the cladding power stripper 523 and the output fiber 526, close to the cladding power stripper 523. In this arrangement, an all-fiber laser system 900 comprises the all-fiber laser system 500 in combination with the wavelength-dependent spatial filter 901. The wavelength-dependent spatial filter 901 is configured to spatially deviate backward-propagating SRS light having a wavelength different from a signal wavelength, thereby inhibiting coupling of the SRS light into a core of the signal fiber. By way of example and not limitation, backward-propagating SRS light propagating in the core may be spatially transferred into cladding modes, with the transferred optical energy being absorbed, dissipated, or otherwise removed by the cladding power stripper 523 positioned upstream.

Such spatial deviation is feasible because the SRS light typically has a wavelength in a range of approximately 1110-1130 nm, which differs from a signal wavelength in a range of approximately 1030-1080 nm for Yb³⁺-doped fiber lasers. The wavelength-dependent spatial filter may be designed to provide strong core-to-cladding mode coupling at the SRS wavelength while substantially inhibiting phase-matched cladding modes at the signal wavelength, thereby suppressing coupling of backward-propagating SRS light into the signal fiber while allowing signal light to propagate with minimal loss.

While preferred embodiments of the present disclosure have been illustrated and described, it will be understood by those skilled in the art that various changes, substitutions, and modifications may be made without departing from the spirit and scope of the appended claims. In particular, other all-fiber laser systems may adopt different arrangements, quantities, or configurations of one or more side-pumped signal-and-pump combiners to achieve similar, equivalent, or alternative technical effects, and such implementations are considered within the scope of the present disclosure. Accordingly, the foregoing description and the accompanying drawings are provided for purposes of illustration only and are not intended to limit the scope of the claims.

What is claimed is:

1. An all-fiber laser system for processing highly reflective materials, comprising:
a seed laser configured to generate a signal laser beam at a processing wavelength;
at least one pump light source configured to provide a pump light at a pump wavelength;
one or more isolating side-pumped signal-and-pump combiners, each comprising:
a signal fiber configured to transmit the signal laser beam;
one or more pump fibers configured to deliver the pump light; and
a coupling region in which the pump light is side-coupled into the signal fiber while the signal laser beam propagates without interruption;
a gain fiber optically coupled to the signal fiber of each of the one or more isolating side-pumped signal-and-pump combiners, the gain fiber being doped with rare-earth ions and configured to amplify the signal laser beam using the pump light;
a cladding power stripper disposed downstream of the gain fiber and configured to dissipate a cladding-guided optical radiation propagating in at least one of a forward direction or a backward direction along both the gain fiber and the signal fiber of each of the one or more isolating side-pumped signal-and-pump combiners, while allowing a core-guided signal radiation to propagate substantially unaffected; and
an output fiber optically coupled to the gain fiber and configured to deliver an amplified output laser beam to a reflective workpiece, wherein:
the one or more isolating side-pumped signal-and-pump combiners are configured to provide intrinsic isolation that inhibits a backward-propagating signal light and a backward stimulated Raman scattering (SRS) light from coupling into the one or more pump fibers of each of the one or more isolating side-pumped signal-and-pump combiners, thereby reducing propagation of a back-reflected optical radiation from highly reflective materials toward the at least one pump light source;
the all-fiber laser system operates without free-space optical components between the seed laser and the output fiber, thereby enhancing resistance to any optical damage caused by a back reflection; and
the cladding power stripper is non-wavelength-selective and removes the optical radiation based on spatial mode confinement rather than wavelength.

2. The all-fiber laser system of claim 1, further comprising a wavelength-dependent spatial filter disposed between the cladding power stripper and the output fiber, wherein the wavelength-dependent spatial filter is configured to spatially deviate the backward-propagating SRS light, having an SRS wavelength different from the processing wavelength, and to provide enhanced core-to-cladding mode coupling at the SRS wavelength while inhibiting phase-matched cladding modes at the processing wavelength, such that the backward-propagating SRS light is inhibited from coupling into the signal fiber while the signal light at the processing wavelength propagates with minimal loss, wherein the backward-propagating SRS light which is guided in a core of the output fiber is converted by the wavelength-dependent spatial filter into a cladding-guided radiation, and wherein the converted cladding-guided radiation is dissipated by the cladding power stripper positioned upstream of the wavelength-dependent spatial filter.

3. The all-fiber laser system of claim 1, wherein the highly reflective materials comprise aluminum, brass, copper, or gold.

4. The all-fiber laser system of claim 1, wherein each of the one or more isolating side-pumped signal-and-pump combiners comprises a fused fiber structure in which the one or more pump fibers are thermally fused to an outer cladding of the signal fiber.

5. The all-fiber laser system of claim 4, wherein the pump light is coupled into the signal fiber via cladding pumping while the signal laser beam propagates in a single-mode or few-mode core.

6. The all-fiber laser system of claim 1, wherein the one or more isolating side-pumped signal-and-pump combiners are configured to prevent direct optical continuity between the one or more pump fibers and the signal core.

7. The all-fiber laser system of claim 1, further comprising at least one fiber Bragg grating (FBG) configured to define a laser cavity or stabilize an output wavelength.

8. The all-fiber laser system of claim 7, wherein the output fiber has a numerical aperture (NA) configured to reduce a probability that the back-reflected optical radiation is coupled into the laser cavity and further amplified to cause instability of the all-fiber laser system.

9. The all-fiber laser system of claim 1, wherein the gain fiber has a large mode area (LMA) core to reduce nonlinear effects during a high-power operation.

10. The all-fiber laser system of claim 1, wherein the one or more isolating side-pumped signal-and-pump combiners enable power scaling beyond 1 kW without use of free-space isolators.

11. The all-fiber laser system of claim 1, wherein the all-fiber laser system is configured to operate in a continuous-wave (CW) mode or a modulated CW mode in welding or cutting reflective metals.

12. The all-fiber laser system of claim 1, wherein the one or more isolating side-pumped signal-and-pump combiners are configured to reduce a leakage of a back-reflected optical power into the one or more pump fibers by at least 5 dB relative to an end-pumped signal-and-pump combiner under otherwise identical operating conditions.

13. The all-fiber laser system of claim 12, wherein a reduction in the leakage is at least 7 dB when averaged over a back-reflected signal light and the backward-propagating SRS light.

14. The all-fiber laser system of claim 1, wherein the backward-propagating SRS light amplified in the gain fiber is inhibited from coupling into the one or more pump fibers by the one or more isolating side-pumped signal-and-pump combiners.

15. The all-fiber laser system of claim 1, wherein the one or more pump fibers are configured such that a back-reflected signal light and the backward-propagating SRS light do not satisfy a numerical aperture or mode-matching condition required for coupling into the one or more pump fibers.

16. The all-fiber laser system of claim 1, wherein the at least one pump light source comprises one or more 500-watt-class laser diodes directly connected to the one or more pump fibers.

17. The all-fiber laser system of claim 16, wherein the at least one pump light source is configured to operate continuously at a full rated power for at least 72 hours while exposed to a back-reflected optical power exceeding 2 kilowatts, without degradation of laser output power, spectral characteristics, or beam quality.

18. The all-fiber laser system of claim 1, wherein the one or more isolating side-pumped signal-and-pump combiners provide an intrinsic immunity of the at least one pump light source to the back-reflected optical radiation generated during high-power processing of reflective materials.

19. The all-fiber laser system of claim 18, wherein the intrinsic immunity is achieved without optical isolators, circulators, or free-space optical components.

20. The all-fiber laser system of claim 1, wherein the one or more isolating side-pumped signal-and-pump combiners are configured for a continuous laser operation at output power levels of at least 3 kilowatts.

21. The all-fiber laser system of claim 1, wherein the all-fiber laser system is configured to process copper at a normal incidence without triggering a protective shutdown or power derating in response to a back-reflected optical power.

22. The all-fiber laser system of claim 21, further comprising a back-reflection monitor disposed between the cladding power stripper and the output fiber, the back-reflection monitor being configured to detect a backward-propagating optical radiation reflected from the reflective workpiece and to trigger a protective shutdown of the all-fiber laser system when the detected backward-propagating optical radiation exceeds a predetermined threshold.

23. The all-fiber laser system of claim 1, wherein the one or more isolating side-pumped signal-and-pump combiners maintain a stable operation under a directly measured back reflection generated during material processing.

24. The all-fiber laser system of claim 1, wherein isolation performance of the one or more isolating side-pumped signal-and-pump combiner is verified by a stress simulation test introducing a controlled back-reflected optical power and the backward-propagating SRS light.

25. The all-fiber laser system of claim 1, wherein the one or more isolating side-pumped signal-and-pump combiners are configured to suppress a self-pulsation induced by a backward-propagating optical radiation including the SRS light amplified in the gain fiber.

26. The all-fiber laser system of claim 1, wherein the one or more isolating side-pumped signal-and-pump combiners are configured to prevent the backward-propagating SRS light from inducing a rapid population inversion collapse in the gain fiber.

27. The all-fiber laser system of claim 1, wherein suppression of the backward-propagating SRS light limits a peak optical power generated from self-pulsation within the output fiber to a level below a damage threshold of the output fiber.

28. The all-fiber laser system of claim 27, wherein the output fiber is protected from optical peak powers exceeding 1 megawatt, thereby preventing a catastrophic optical damage (COD).

29. The all-fiber laser system of claim 1, wherein the one or more isolating side-pumped signal-and-pump combiners are configured to prevent generation of an optical self-pulsation having peak power levels of 3 megawatts or greater.
